(19) United States
(12) Patent Application Publication
(10) Pub. No.: US 2006/0282393 A1
(43) Pub. Date: Dec. 14, 2006

(54) Systems and methods for providing access to product license information

(76) Inventors: Marjorie B. Sladek, Granite Bay, CA (US); Kathy K. Harms, Greeley, CO (US); Paul T. Dechene, Auburn, CA (US); Derrick Edward Hartman, Cary, NC (US); Robert D. Rice, Kennesaw, GA (US); Russ Kwan, Loveland, CO (US); Quintin May, Tampa, FL (US); Lorraine D. Mattock, Loveland, CO (US); Michael Ciantar, Blackburn (AU); Rabea Taylor, Monument, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/152,313

(22) Filed: Jun. 13, 2005

(51) Int. Cl. G06F 17/60

(52) U.S. Cl. 705/59

(57) ABSTRACT

Systems and methods for providing access to product license information include validating a license redemption record when a customer redeems a software license via a license server. A customer site identifier is associated with the license redemption record, and a customer data warehouse is formed that includes license redemption records associated with the same customer site identifier. A customer associated with the site identifier can access the license redemption records in the customer data warehouse.

### BACKGROUND

Most software manufacturers license their products, and require a user to register to gain access to the software. Some vendors provide license-to-use entitlement certificates with their software products that contain unique sales order identifiers. In some cases, customers can utilize the certificate to redeem product license keys by accessing a web site or other facility providing the unique sales order number, selecting the product number, and entering customer profile information. The information entered by the customer may be recorded when a license key is issued.

Customers typically cannot access the historical records maintained by the vendors to substantiate the customer's legal use of the software. Additionally, organizational mergers, acquisitions, consolidations, and turnover often result in knowledge regarding ownership of licenses being lost.

Further, as part of a license agreement, the vendor may have the right to periodically audit the customer's use of the software. The audit process can be difficult and time-consuming when records are not updated after an organization has changed due to a merger, acquisition, or other event.

### SUMMARY

Embodiments of systems and methods for providing access to product license information include validating a license redemption record when a customer redeems a software license via a license server. A customer site identifier is associated with the license redemption record, and a customer data warehouse is formed that includes license redemption records associated with the same customer site identifier. A customer associated with the site identifier can access the license redemption records in the customer data warehouse.

### BRIEF DESCRIPTION OF THE FIGURES

Embodiments disclosed herein may be better understood by referencing the accompanying drawings. The use of the same reference symbols in different drawings indicates similar or identical items.

FIG. 1 is a schematic block diagram of an embodiment of a network configured with facilities that allow access to product registration information; and

FIGS. 2 through 10 show embodiments of a user interface that allows customers to access product registration information; and

FIG. 11 is a flow diagram of an embodiment of a method for allowing customers to access product registration information.

### DETAILED DESCRIPTION

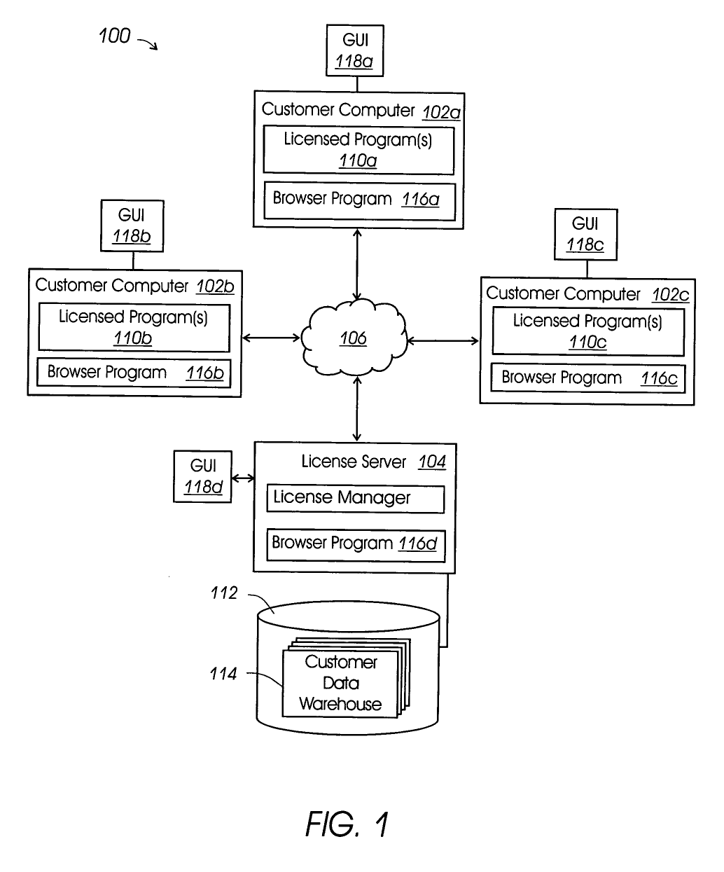

Embodiments of systems and techniques disclosed herein can be used to allow a customer to view and/or update database records for licensed products such as software. FIG. 1 depicts an embodiment of computer system 100 that can include one or more customer computers 102 configured to communicate with license server 104 via network 106. Note that to simplify notation, similar components and systems designated with reference numbers suffixed by the letters “a”, “b”, “c” or “d” are referred to collectively herein by the reference number alone. Although such components and systems may perform similar functions, they can differ in some respects from other components with the same reference number. For example, customer computers 102a, 102b, 102c may be collectively referred to as customer computers 102, however, customer computers 102a, 102b, 102c may or may not include the same number or type of components, or use the same communication protocol(s).

Customer computers 102 can run one or more licensed programs 110, which may be installed on customer computer 102 or accessible from a centralized server (not shown) via network 106. Whether the programs 110 are purchased from a vendor via network 106, a retail store, or acquired in some other manner, the licenses must typically be registered with the vendor before or shortly after the programs 110 are used on customer computers 102. Registration may be accomplished via network 106, by telephone, or other suitable method. The vendor typically maintains license server 104 with a database 112 of license records that can include information such as the name and version of the licensed program 110, a serial number associated with a particular copy of program 110, the date the copy was created, and other relevant information.

To register program 110, the customer may be required to provide identifying information, such as the serial number of program 110 and identifiers for the customer and the customer's organization, to license manager 108 to redeem the license. License manager 108 may also receive other information, such as identifiers for customer computer 102 and licensed program 110, during registration via network 106 or other input method to allow license manager 108 to validate the license. When the license is validated, license manager 108 creates a license redemption record, and, if not previously created, a customer data warehouse 114 associated with the customer's organization identifier and/or the customer's identifier. All license redemption records associated with the same customer organization identifier are typically stored in the corresponding customer data warehouse 114.

Customer computers 102 can include network browser program 116 that generates a graphical user interface 118 to enable customers to login to license server 104 through license manager 108 and access license redemption records for the customer's organization. Customer login names can include an identifier for at least a portion of the organization that can be associated with corresponding customer data warehouse 114. For example, the network domain name for the organization (e.g., ocs.com) can be associated with the data warehouse 114 and customer email addresses (e.g., john.doe@ocs.com). Other suitable identifiers can be used. License manager 108 authorizes customers based on login information and provides access to data warehouse 114 corresponding to the customer/organization identifier.

License manager 108 can also be configured to distinguish between types of users, such as, for example, asset managers and authorized users. In some embodiments, the provider of licensed programs 110 can authorize customers as asset managers, and asset managers can designate customers within their organization as authorized users. License manager 108 can control the level of access to data warehouse 114 based on a user's type. For example, asset managers can be granted access to read and write license records while authorized users may only be able to read the records.

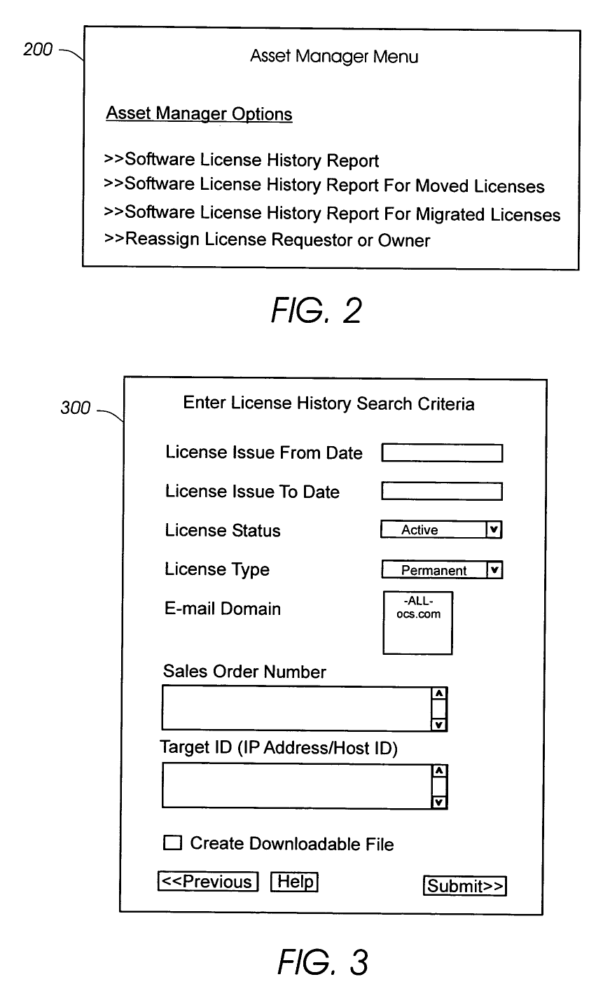

FIGS. 2 through 11 show embodiments of a user interface for an asset manager to access product registration information. Authorized user interfaces are typically a subset of the features that are available for the asset manager. Referring to FIG. 2, an embodiment of a menu 200 is shown that allows an asset manager to select from options to request a report of a license's history; a report of activity showing that a licensed program was moved from one computer to another, or from one type of platform to another; a report of activity showing that a licensed product has migrated from one product structure to another product structure; and an option to allow the customer to reassign the owner of a license and/or the name of the person who requested the license. Note that other options for accessing the product license information can be included on menu 200 in addition to, or instead of, the options shown.

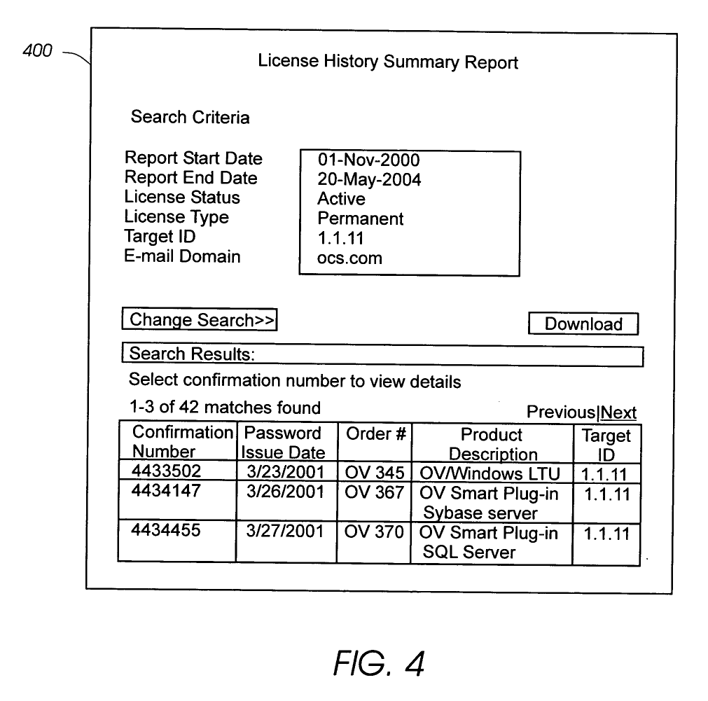

FIG. 3 shows an embodiment of an interface 300 that can be presented when the user selects an option to generate a report of a license's history. In the example shown, the user can select options and enter data for various search criteria such as the date on which license manager 108 will begin to search for a license record; the date on which the report will stop searching for a license record; license status (e.g., active, deleted); license type (e.g., permanent, evaluation); company e-mail domain, the sales order number(s), and/or a network address or customer computer identifier. Interface 300 can also include other selectable options, such as an option to create a file containing the results of the search, a help option, an option to return to the previous interface, and an option to submit the search.

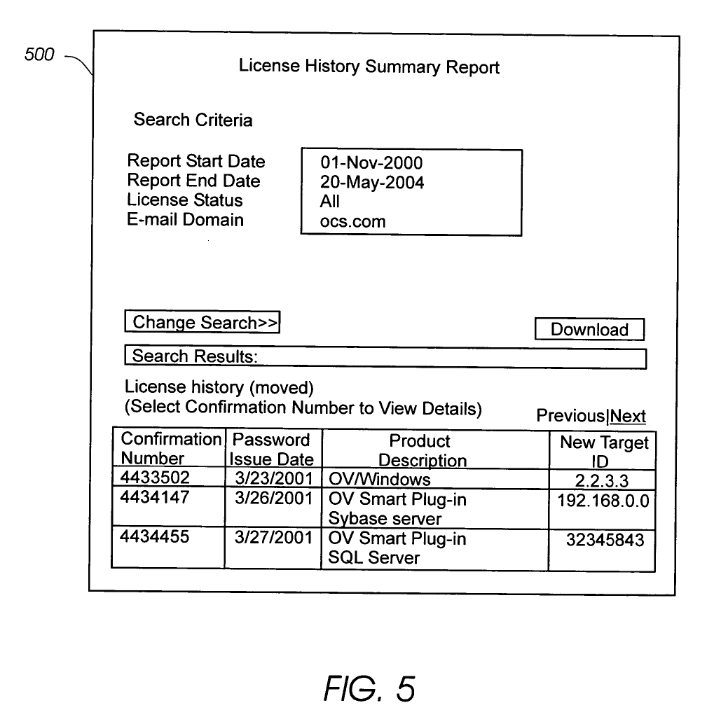

FIG. 4 shows an embodiment of an interface display 400 for a license history summary report. The report includes a summary of the search criteria that was entered via interface 300 (FIG. 3), such as report start date, report end date, license status, license type, target ID (if used), order number (if used), and company e-mail domain.

An option to change search can be provided on display 400 to allow the user to modify the report search parameters, typically resulting in different output for the report. An option to download the report file is available when the Create Downloadable Report File check box is marked on the license history search interface 300. When selected, the user is prompted to enter the location to which the file containing the report will be saved. In some embodiments, the user can select a format for a particular application program, such as Word or Excel by Microsoft Corporation of Redmond, Wash.

A table indicating information pertinent to the history of all licenses meeting the search criteria is presented including confirmation number, password issue date, sales order number, product description, and target ID. The confirmation number is assigned when the license is assigned to a new user. The target ID indicates the customer computer 102 (FIG. 1) for which the license was issued.

Column headings in the table may be selected to sort the data by that column. A visual indicator in the heading of the column used for sorting can be provided, such as highlighting or a character such as “ [symbol] ” or “ [symbol] ” that also indicates ascending or descending order.

Additionally data in the table can linked to allow the user to view further detail regarding the license. For example, the confirmation number can be linked to provide a more detailed report when the confirmation number is selected.

When the number of search results is greater than the number that will fit on one page, the Previous|Next options can be used to allow the user to move backward or forward through the results one page, as applicable.

Other options that are not shown, such as to view a disclaimer regarding the accuracy of the report, to get help regarding the features available, and to finish reviewing the displayed report and exit the interface display 400, among others, can also be provided.

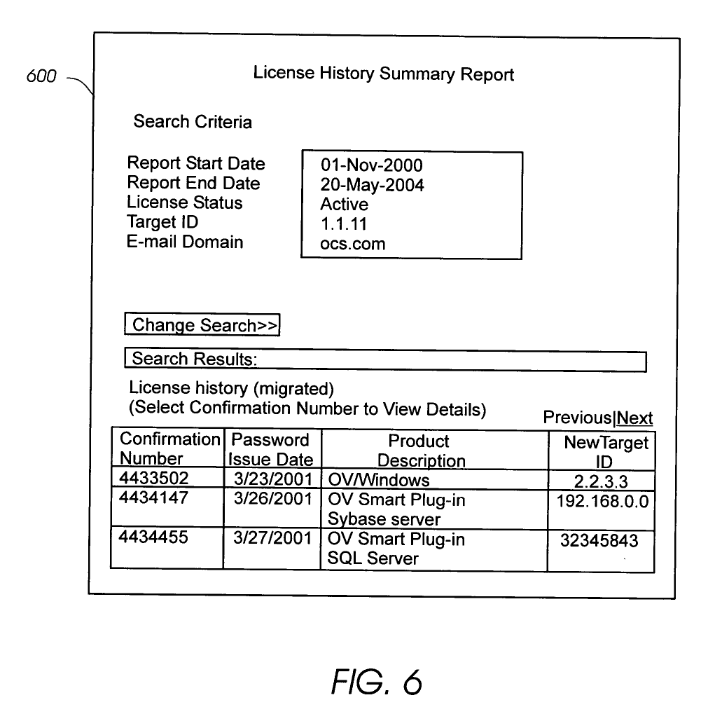

FIG. 5 shows an embodiment of an interface display 500 for a license history summary report that shows licenses that have been moved from one customer server or customer computer 102 to another. The report includes a summary of the search criteria that was entered via interface 300 (FIG. 3), such as report start date, report end date, license status, license type, target ID (if used), order number (if used), and company e-mail domain.

Interface 500 can also include the search results in table format with information pertinent to the history of all licenses meeting the search criteria, such as confirmation number, password issue date, product description, and new target ID. The new target ID indicates the customer server or customer computer 102 (FIG. 1) for which the license was issued.

Similar to interface 400 (FIG. 4), interface 500 can include an option to change search and to download the report file. Likewise, column headings in the table may be selected to sort the data by that column and data in the table can linked to allow the user to view further detail regarding the license. Previous|Next options can be provided when the search results span across more than one page. Other suitable options for interface 500 can also be provided.

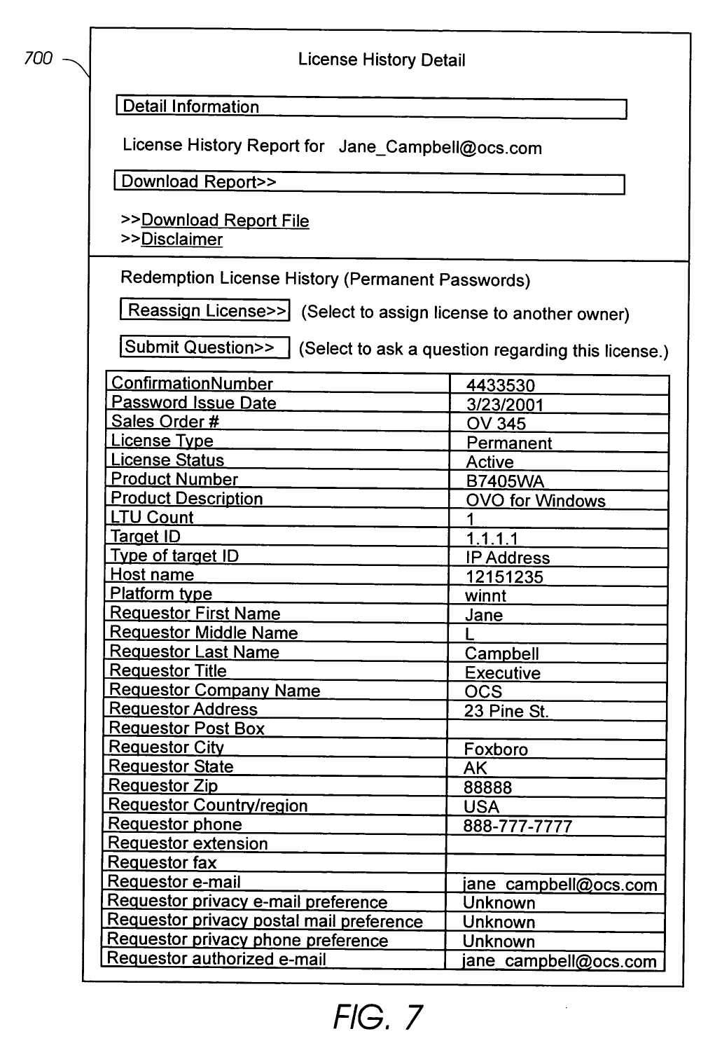

FIG. 6 shows an embodiment of an interface display 600 for a license history summary report for licenses that have been upgraded from an old version to a newer product and/or version. The upgrade is also referred to as “migrated”. The report includes a summary of the search criteria that was entered via interface 300 (FIG. 3), such as report start date, report end date, license status, license type, target ID (if used), and company e-mail domain.

Interface 600 can also include a table listing all licenses meeting the search criteria. The information can include confirmation number, password issue date, product description, and new target ID. The new target ID indicates the customer server or customer computer 102 (FIG. 1) entered for the license during the migration process.

Similar to interface 400 (FIG. 4), interface 600 can include an option to change search and to download the report file. Likewise, column headings in the table may be selected to sort the data by that column and data in the table can linked to allow the user to view further detail regarding the license. Previous|Next options can be provided when the search results span across more than one page. Other suitable options for interface 600 can also be provided.

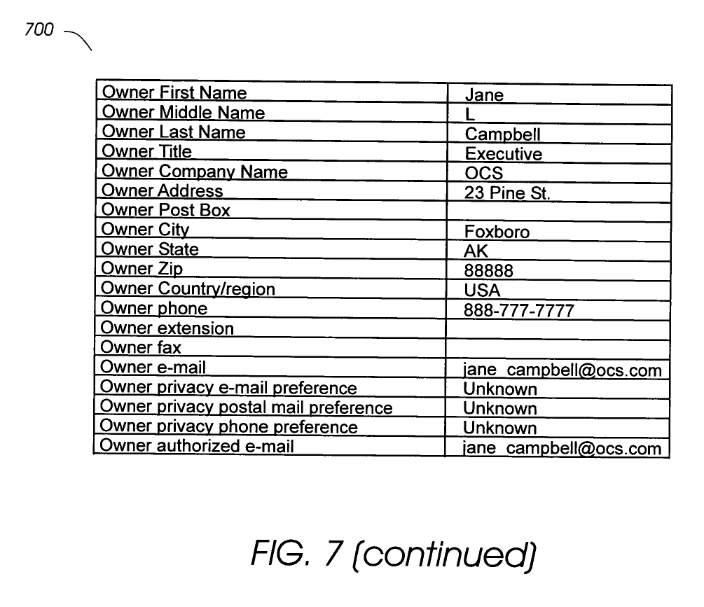

Referring now to FIG. 7, an embodiment of a detailed license history report interface 700 is shown that includes detailed information for a selected license. Interface 700 is presented when a particular license record is selected from one of the summary license reports 400, 500, 600. Interface 700 shows an example of parameters that can be included in an original license record.

In the embodiment shown, Detail information section lists login information for the user that requested the report. Download report file section includes an option to download the report file to a location specified when the option to download the report is selected. A table showing information in the record can include parameters such as Confirmation number, Password issue date, Sales order #, License type, License status, Product number, Product description, Number of licenses to use (LTU count), Target ID of the computer for which the license was issued, Type of target ID indicating the type of machine on which the license is authorized for use, the name of the computer associated with the license; platform type indicating the type of operating system for which the license was issued, and name and contact information for the requestor and the owner. A Submit Question option can be included to allow the user to send a question or comment regarding the selected license to the vendor.

While the information in each type of detailed license record, e.g., Original, Moved, and Migrated records, is similar, there can be some differences. For example, a record for a moved license can include parameters such as the previous identifier for the computer on which the license was issued; the previous type of location on which the license was issued; the previous name of the computer on which the license was issued, the new identifier of the computer for which the license was issued, the type of computer on which the new license is authorized for use, and the new name of the computer associated with the moved license.

For a migrated license, parameters such as the identified for the previous computer for which the license was issued, the previous type of computer on which the license was issued, the name of the previous computer on which the license was issued, the identifier of the new computer for which the license was issued, the type of computer on which the new license is authorized for use, and the name of the new computer associated with the migrated license, can be included.

Note that if a license is moved or migrated more than once, the license record can expand to show the entire history. An option can be provided in interface 700 to allow the user to expand or reduce the number of transactions shown for the license.

Additionally, a Reassign License option can be presented in interface 700 to allow the asset manager to enter a new requester or owner for the license. When a license is first issued, a Password Certificate is created. The Password Certificate is sent, usually via e-mail, to the requestor. In some embodiments, the owner of the e-mail address is the authorized requestor and owner of the license, and an asset manager may reassign issued licenses to a new authorized owner or requestor.

Licenses can typically be reassigned individually or in a mass transaction. A single license certificate can be reassigned from the license record detail report. Only the selected record is affected by the transaction.

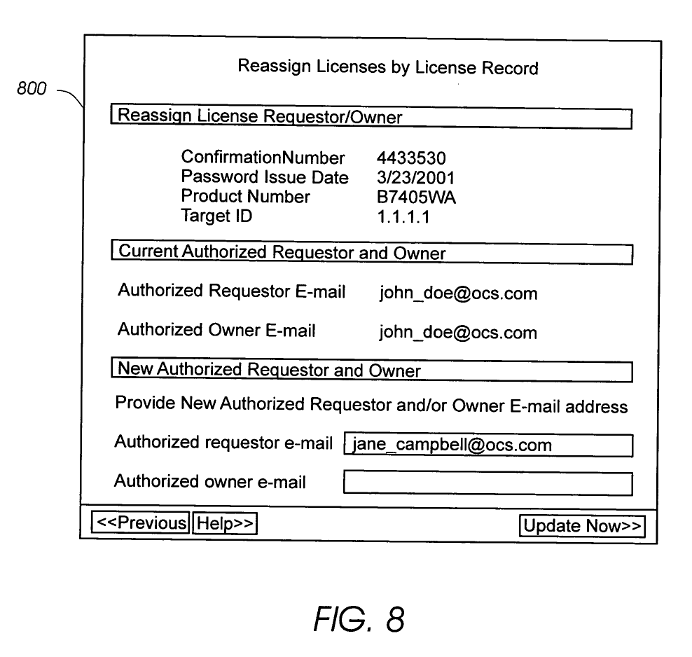

Referring to FIG. 8, an embodiment of a Reassign licenses interface 800 is shown. Interface 800 can present information such as confirmation number, password issue date, product number, target ID, and an identifier such as an e-mail address for the current requestor and owner. The asset manager can enter the e-mail address of the new authorized requestor and/or the new authorized owner. If only one field value is entered, then the one left blank will typically not be changed. An Update Now option can be selected to enter the change in the record.

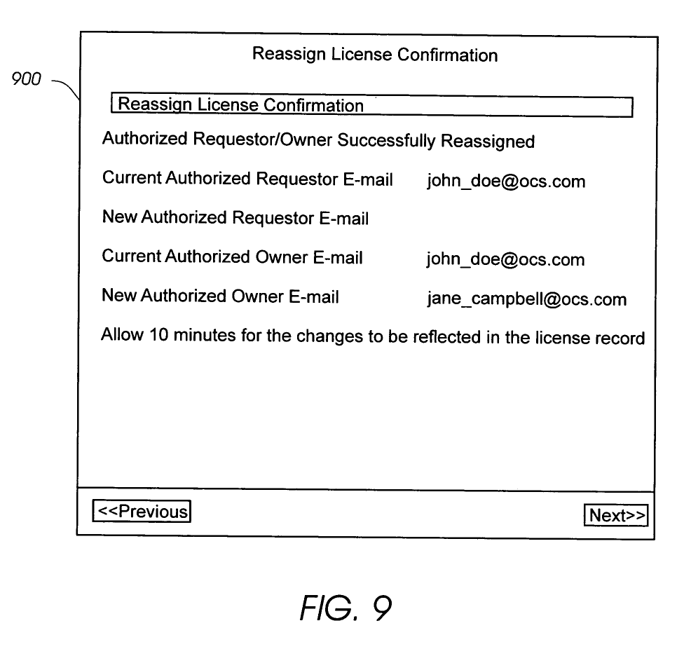

FIG. 9 shows an embodiment of a confirmation page that can be displayed to indicate that the change was successfully entered, and showing the old and new authorized owner/requestor.

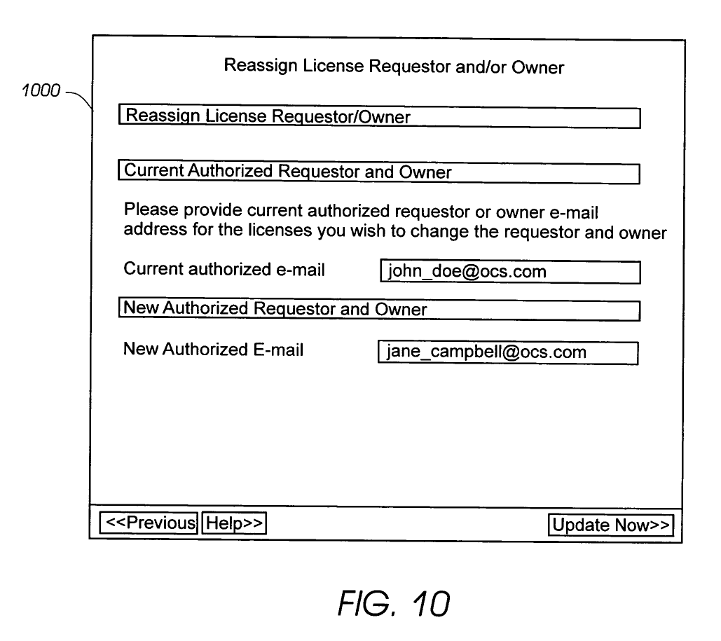

Referring to FIG. 10, an embodiment of an interface 1000 that allows an asset manager to reassign all licenses associated with a particular owner and requestor is shown. Interface 1000 can be used to reassign multiple licenses in a single transaction, for example, when an employee has left a company or all licenses assigned to one e-mail address need to be assigned to a different e-mail address. The asset manager can access interface 1000 by selecting the Reassign license option from the main menu shown in interface 200 (FIG. 2).

In the embodiment of interface 1000 shown, the asset manager can enter the current authorized e-mail address and the new authorized e-mail address. The Update Now option can be selected to enter the new email address for the owner/requestor in all license records associated with the previous email address. A confirmation page similar to interface 900 (FIG. 9) can be presented when the change has been entered successfully.

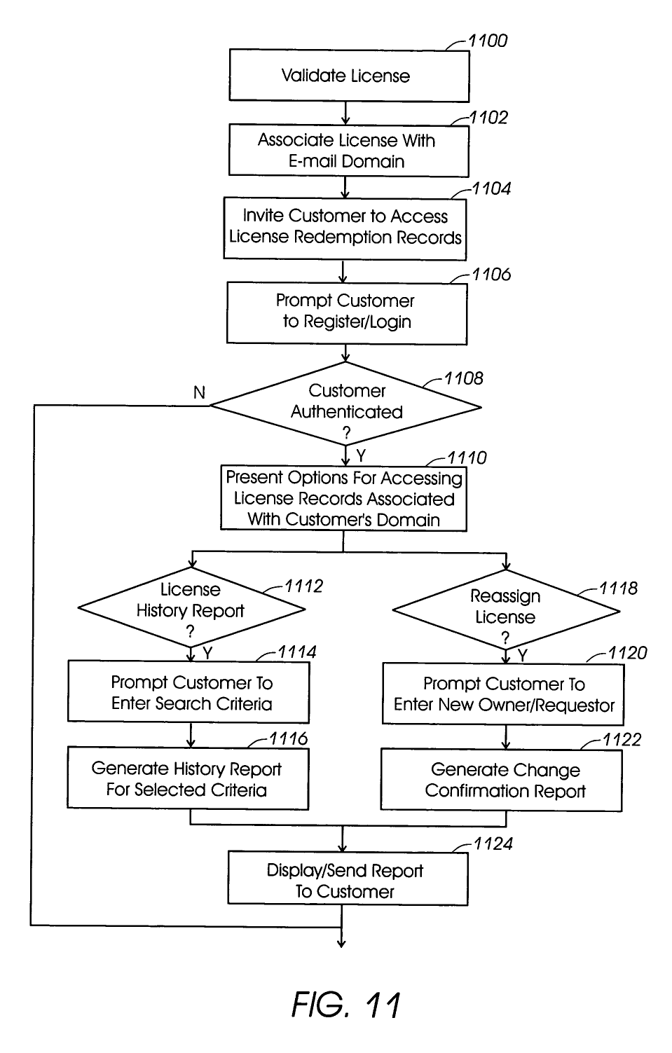

Referring now to FIGS. 1 and 11, FIG. 11 shows a flow diagram of an embodiment of processes that can be performed by license manager 108. Process 1100 can include validating a license redemption record when a customer redeems a software license via license server 108. Process 1102 can include associating a customer site identifier with the license redemption record. Process 1102 can also include forming customer data warehouse 114 to store license redemption records associated with the same customer site identifier.

The customer site identifier can be any suitable identifier, and in some embodiments, the domain name associated with the customer's email address is used because the domain will typically be unique to an organization and readily available to the customer. Additionally, multiple customers in the organization will typically have the same identifier, enabling all records associated with the organization to be grouped and available for access/search in the same data warehouse 114.

Once a customer has redeemed/requested a license and the license record has been formed, process 1104 can include issuing an invitation to the customer to access the license redemption records in data warehouse 114. In some embodiments, the invitation can be sent to customer's email address and includes a link to login to access data warehouse 114 via license manager 108.

Process 1106 can prompt the customer to enter information that can be used to authenticate the customer before allowing access to the license redemption records in data warehouse 114. In some embodiments, for example, the customer logs in using his/her email address and a password for authentication. In process 1108, the customer is allowed to access the data warehouse 114 associated with a site identifier when the site identifier matches the domain name in the customer's e-mail address.

In some embodiments, an administrator of license server 104 can authorize one or more customers as asset managers that are allowed to modify the license redemption records. In turn, asset managers can be allowed to authorize other customers associated with the customer site identifier to view the license redemption records. Accordingly, process 1110 can present options to generate various reports and reassign license records based on whether the customer that has logged in is designated as an asset manager or an authorized customer. Generally, asset managers will be given access to read and reassign license records, whereas authorized uses will be given access to read the records via history reports.

If the customer selects an option to generate a license history report in process 1112, process 1114 can prompt the customer to enter search criteria to search the license redemption records. In some embodiments, the search criteria can include license issue to/from dates, license status, license type, sales order number(s), and an identifier of the customer's computer 102. Other suitable search criteria can be used.

Process 1116 generates a report regarding the history of the license(s) based on the search criteria entered by the customer.

If the customer selects an option to reassign one or more licenses in process 1118, process 1120 can prompt the customer to enter the old owner/requestor and/or the new owner/requestor. In some embodiments, multiple licenses associated with a single owner/requestor can be reassigned to a new owner/requestor in one transaction. Licenses can also be reassigned to a new owner/requestor on an individual basis.

Process 1122 generates a confirmation report to indicate whether the reassignment was successfully entered in the license records.

The logic modules, processing systems, and circuitry described herein may be implemented using any suitable combination of hardware, software, and/or firmware logic instructions, such as general purpose computer systems, workstations, servers, Field Programmable Gate Arrays (FPGAs), Application Specific Integrated Circuit (ASICs), magnetic storage media, optical storage media, and other suitable computer-related devices. The logic modules can be independently implemented or included in one of the other system components. Similarly, other components are disclosed herein as separate and discrete components. These components may, however, be combined to form larger or different software modules, logic modules, integrated circuits, or electrical assemblies, if desired.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, identifiers instead of, or in addition to, e-mail addresses and network domain names can be used to associate customers, customer computers, and license records. Additionally, although examples for licensed programs 110 were presented herein, license manager 108 can be used to track a variety of different types of licensed or leased products.

In the claims, unless otherwise indicated the article “a” is to refer to “one or more than one”.

We claim:

1. A computer product comprising:
logic instructions operable to:
receive a request to access product license information for at least a portion of an organization;
access a product license information database for multiple unrelated organizations to retrieve the product license information associated with the identifier, in response to the request; and
provide the product license information to a user associated with the at least a portion of the organization.

2. The computer product of claim 1 wherein the identifier includes a network identifier of the at least a portion of the organization.

3. The computer product of claim 1 wherein the identifier includes the electronic mail domain name of the at least a portion of the organization.

4. The computer product of claim 1 further comprising:
logic instructions operable to:
allow the user to update the product license information associated with the at least a portion of the organization.

5. The computer product of claim 1 further comprising:
logic instructions operable to:
distinguish between types of users including at least one of the group consisting of: asset managers and authorized users, wherein asset managers can designate users as authorized users.

6. The computer product of claim 1 further comprising:
logic instructions operable to:
allow the user to select an option to request license activity for which a new product password was generated.

7. The computer product of claim 1 further comprising:
logic instructions operable to:
allow the user to select an option to request license activity for products that have moved from one server to another server or from one platform type to another platform type.

8. The computer product of claim 1 further comprising:
logic instructions operable to:
allow the user to select an option to request license activity for a licensed product that has migrated from one product structure to another product structure.

9. The computer product of claim 1 further comprising:
logic instructions operable to:
allow the user to select an option to request the license information based on one or more specified dates.

10. The computer product of claim 1 further comprising:
logic instructions operable to:
allow the user to select an option to request the license information based on status of the licenses.

11. The computer product of claim 1 further comprising:
logic instructions operable to:
allow the user to select an option to request the license information based on sales order number(s) of the licenses.

12. The computer product of claim 1 further comprising:
logic instructions operable to:
allow the user to select an option to request the license information based on identification of a particular network address.

13. The computer product of claim 1 wherein:
logic instructions operable to:
allow the user to select an option to request the license information to be output in a format that can be downloaded across the network.

14. The computer product of claim 1 further comprising:
a computer processor configured to execute the logic instructions.

15. A computer-implemented method comprising:
validating a license redemption record when a customer redeems a software license via a license server;
associating a customer site identifier with the license redemption record;
forming a customer data warehouse including license redemption records associated with the same customer site identifier; and
allowing a customer associated with the site identifier to access the license redemption records in the customer data warehouse.

16. The method of claim 15, further comprising:
authenticating the customer before allowing the customer to access the license redemption records in the data warehouse.

17. The method of claim 15, wherein the site identifier is a network domain name, the method further comprising:
allowing the customer to access the data warehouse when the site identifier matches the domain name in the customer's e-mail address.

18. The method of claim 15, further comprising:
allowing an administrator of the license server to authorize one or more customers as asset managers, wherein the asset managers are allowed to modify the license redemption records.

19. The method of claim 18, further comprising:
allowing the asset manager to authorize other customers associated with the customer site identifier to view the license redemption records.

20. The method of claim 15, further comprising:
allowing the customer to search the license redemption records according to at least one of the criteria consisting of: license issue date, license status, license type, sales order number(s), and customer computer identifier.

21. The method of claim 15, further comprising:
allowing the customer to select options to generate reports regarding the history of the licenses.

22. The method of claim 15, further comprising:
allowing the customer to reassign one or more licenses.

23. The method of claim 18, further comprising:
allowing the customer to reassign the owner of a license and/or the name of the person who requested the license.

24. A computerized apparatus comprising:
means for associating a customer site identifier with a license record;
means for associating license records with the same customer site identifier;
means for allowing a customer associated with the site identifier to access the license records; and
means for allowing the customer to access the license records associated with the site identifier when the site identifier matches the domain name in the customer's e-mail address.
